(19) United States
(12) Patent Application Publication
(10) Pub. No.: US 2011/0254229 A1
(43) Pub. Date: Oct. 20, 2011

(54) SEAL ASSEMBLY

(75) Inventors: Manfred Luttinger, Upper Arlington, OH (US); Gary H. Brawley, Hilliard, OH (US); Steven J. Shaffer, Upper Arlington, OH (US); Bruce Prushing, Gahanna, OH (US); James D. Browning, Columbus, OH (US); Melissa Roshon, Hilliard, OH (US)

(73) Assignee: BATTELLE MEMORIAL INSTITUTE, COLUMBUS, OH (US)

(21) Appl. No.: 13/127,808

(22) PCT Filed: Nov. 6, 2009
(86) PCT No.: PCT/US09/63639

§ 371 Date: Jul. 6, 2011

Related U.S. Application Data
(60) Provisional application No. 61/114,077, filed on Nov. 13, 2008.

(51) Int. Cl. F16J 15/40

(52) U.S. Cl. 277/347

(57) ABSTRACT

Seal assemblies are provided. In one embodiment, an example shaft seal assembly comprises an immiscible fluid and a reservoir structure. The immiscible fluid is immiscible with respect to a contained internal fluid in an enclosure with a penetrating shaft. The reservoir structure is disposed in close proximity to the shaft, and the reservoir structure contains the immiscible fluid. The immiscible fluid of the seal assembly provides a fluid barrier to the internal fluid to limit loss of the internal fluid over time.

### CROSS-REFERENCE TO RELATED APPLICATIONS

This application claims priority from U.S. Provisional Patent Application No. 61/114,077, filed on Nov. 13, 2008, which is incorporated by reference herein in its entirety.

### BACKGROUND

Machines that employ rubber or elastomeric seals along rotating, reciprocating, or translating shafts are susceptible to the longstanding problem of oil leakage through worn seals. This failure of the seal's primary function typically requires replacement of the worn seals, resulting in a reduction in efficiency and an increase in costs attributable to machinery downtime and lost production, along with replacement costs. In addition, in some manufacturing operations, seal replacement is impractical to perform.

The present application describes embodiments of seal assemblies that overcome or at least limit the problem of oil leakage due to excessive seal wear typical of current seal assemblies.

### SUMMARY

In one embodiment, a seal assembly is provided. The seal assembly comprises: an immiscible fluid, the immiscible fluid being immiscible with respect to an internal fluid; and a reservoir structure disposed in close proximity to a shaft, the reservoir structure defining the placement of the immiscible fluid with respect to the internal fluid; the immiscible fluid thereby providing a fluid barrier to the internal fluid to limit a loss of the internal fluid. In this case, the seal is a fluid seal that provides essential non-contact sealing between the stationary case and solid seal parts and the solid shaft.

In another embodiment, a seal assembly is provided. The seal assembly comprises: an immiscible fluid, the immiscible fluid being immiscible with respect to a lubricating oil for, e.g., lubricating gears, bearings, or shafts; and a reservoir structure disposed in close proximity to the shaft, the reservoir structure defining the placement of the immiscible fluid with respect to the lubricating oil; the immiscible fluid thereby providing a fluid barrier to the lubricating oil to limit a loss of the lubricating oil over time.

In yet another embodiment, a seal assembly is provided. The seal assembly comprises: a seal structure in close proximity to a shaft, the seal structure comprising a primary seal material and an immiscible fluid; and the immiscible fluid being released from the seal structure as the seal structure wears; the primary seal material and the immiscible fluid creating a composite barrier to a lubricating oil to limit a loss of the lubricating oil.

The disclosed seal assemblies may provide freedom from wear encountered with traditional rubber seals, correspondingly long leak-free service, and freedom from lubricant contamination of the machine environment.

### BRIEF DESCRIPTION OF THE DRAWINGS

The accompanying figures, which are incorporated in and constitute a part of the specification, illustrate various example systems, methods, results, and so on, and are used merely to illustrate various example embodiments. It should be noted that various components depicted in the figures may not be drawn to scale, and that the various shapes (e.g., rectangular, square) depicted in the figures are presented for purposes of illustration only, and should not be considered in any way as limiting.

FIG. 1 illustrates a cross-sectional view of an example embodiment of a seal assembly.

FIG. 2 illustrates a schematic block diagram of an example embodiment of a seal assembly.

FIGS. 3a and 3b illustrate alternate seal assembly embodiments.

FIG. 4 illustrates a cross-sectional view of an example embodiment of a seal assembly employing a seal structure comprising an immiscible fluid.

### DETAILED DESCRIPTION

The present application describes embodiments of seal assemblies that are suitable for use in providing seals along rotating, reciprocating, or translating shafts, for example. The seal assemblies described in the present application limit or overcome the widely encountered problem of seal wear and eventual leaking, a failure of a seal's primary function.

In one embodiment, a seal assembly is provided. The seal assembly comprises: an immiscible fluid, the immiscible fluid being immiscible with respect to an internally contained fluid, such as a lubricating oil for lubricating gears mounted on a shaft; and a reservoir structure disposed in close proximity to the shaft, the reservoir structure defining placement of the immiscible fluid with respect to the internal fluid; thereby providing an immiscible fluid barrier between the internal fluid and the outside environment.

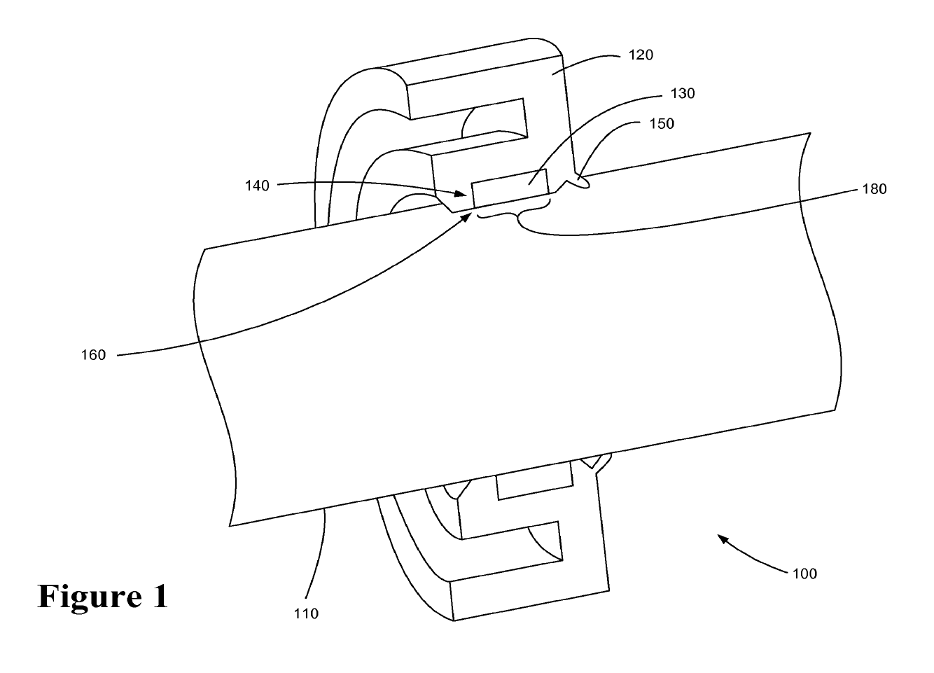

FIG. 1 illustrates a cross-sectional view of an example embodiment of a seal assembly 100. The example seal assembly 100 may be employed in a larger device, such as a gearbox, for example. As shown, seal assembly 100 comprises a seal structure 120 surrounding the circumference of a moving shaft 110. One function of seal structure 120 is to prevent lubricating oil disposed in the interior of the larger device, to the left of seal structure 120 (as shown), from leaking out to the exterior environment, to the right of seal structure 120 (as shown).

Seal structure 120 defines a reservoir structure 140 that retains an amount of an immiscible fluid 130. Example seal structure 120 further defines an optional dust shield 150 for preventing contamination of immiscible fluid 130.

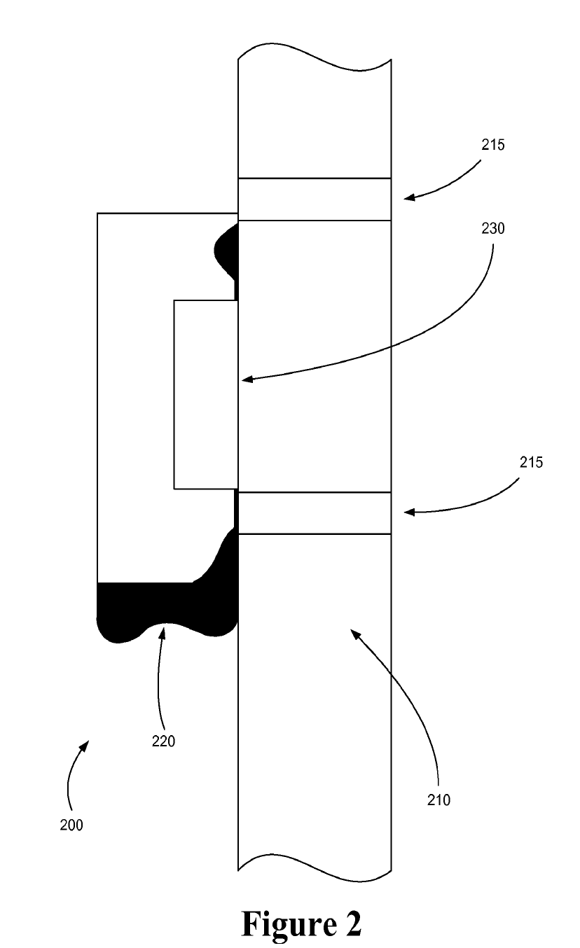

Immiscible fluid 130 may have properties that allow the formation of a fluid barrier 160 to the passage of lubricating oil (illustrated as 220 in FIG. 2) past seal structure 120 and yet remain in place without leaking out. Seal structure 120 can include a mechanism (not shown) for feeding immiscible fluid 130 into reservoir 140 and onto shaft 110, and for holding immiscible fluid 130 in place over the area where the seal is in close proximity or in contact with the shaft—the seal nip zone 180. A small meniscus of immiscible fluid 130 is desired to prevent breakthrough of the lubricating oil and to retain the immiscible fluid in the seal nip zone 180.

### Immiscible Fluids

Immiscible fluid 130 may exhibit such desirable rheological properties as are useful for retention in the reservoir; gradual release from the reservoir, as needed; and thixotropy to inhibit flow outside of the shear zone. Alternatively, immiscible fluid 130 may be modified with additives to incorporate such desirable properties.

At least two types of fluids are immiscible with hydrocarbon oils and greases. First, fluorocarbon fluids are immiscible with practically all organic liquids, including hydrocarbon oils and greases and polyglycol oils. Hydrocarbon and polyglycol oils and greases are the most common machinery lubricants. Moreover, fluorocarbons have substantially higher densities (mass per unit volume) than hydrocarbons and most other organic lubricants. The increased density of fluorocarbons may be beneficial in the retention of lower density, immiscible lubricants. Fluorocarbons may also possess such characteristics as low volatility, high-temperature stability, and non-flammability.

Second, aqueous fluids are immiscible with hydrocarbon oils and greases. Aqueous fluids may be combined with such hydroxyl-functional components as diols or polyols including glycols, glycerin, glycerin acetates, pentaerythritol, polyvinyl alcohol, poly(hydroxyethylmethacrylate); polyacrylic and methacrylic acid, polyvinylpyrrolidone, vinyl ether polymers and copolymers; carbohydrates including starches, cellulosics such as hydroxypropyl methyl cellulose and polysaccharides (i.e. pullulan, starch) and the like, cellulose ethers and carboxymethyl cellulose; natural gums, resins, and hydrocolloids, and the like. Certain nylon terpolymers, such as DuPont's Elvamide 8061 and similar polyamides, are suitable additives for aqueous-alcohol fluid blends. Aqueous fluids may also be modified by inorganic additives, such as soluble salts, to increase density and oil immiscibility and to retard evaporation. Hygroscopic and deliquescent additives are especially useful to retain water over long periods of time. Hydrophilic fumed silica is used effectively to impart thixotropy to aqueous fluids.

Aqueous fluids may be formulated by means of numerous additives to modify the aqueous fluids' physical and rheological properties. Like the fluorocarbon fluids, aqueous fluids may be non-flammable. Unlike fluorocarbons, aqueous fluids may have properties of relatively high volatility, especially at elevated temperatures, miscibility with polyglycol oils, and corrosivity to some metals.

The mechanical concept of the example seal assembly 100 is to provide a close-fitting seal between seal structure 120 and moving shaft 110. In some embodiments, the seal between the seal structure 120 and the shaft 110 will be non-contacting. In other embodiments, the seal structure 120 will be in direct contact with the shaft 110.

The close-fitting seal structure 120 facilitates the formation of a fluid barrier 160 between shaft 110 and seal structure 120. Fluid barrier 160 may wet both shaft 110 and seal structure 120. Where immiscible fluid barrier 160 is maintained in place, seal assembly 100 does not require direct mechanical contact of seal structure 120 and shaft 110 to prevent the internal lubricating oil from passing through seal structure 120 to the exterior environment.

### Fluid Reservoirs

Seal structure 120 and reservoir 140 perform several functions, such as providing a structure for mounting in a stationary housing against a moving shaft; containing a quantity of immiscible barrier fluid to replenish gradual fluid loss in operation; and releasing small quantities of fluid as needed in operation to maintain seal lubrication or maintain the immiscible fluid barrier in place.

Other possible properties of fluid reservoirs include lubricating-oil resistance/inertness; temperature resistance; open-cell, continuous pore structure; rigidity to retain shape under service conditions; flexibility to accommodate shaft surface features and dimensional changes due to temperature fluctuations or wear; and limited or no swelling in contact with the immiscible fluid and/or the lubricant fluid inside the larger device.

Reservoirs may include open-celled polymer foams, such as polyurethanes; and vulcanized rubbers (including polychloroprene rubbers, nitrile rubbers, fluorocarbon rubbers (such as Viton, Aflas, etc.), silicone or fluorosilicone rubbers, styrene-butadiene rubbers, natural rubber (cis or trans), polyisoprene rubber, ethylene-propylene (EPR) or ethylene-propylene-diene (EPDM) rubbers, butyl rubber (polyisobutylene copolymer), or any number of specialty rubbers, such as polyacrylate (homo- and copolymer), hydrin (based on epichlorohydrin), polysulfides, chlorosulfonated polyethylene (e.g., Hypalon), and the like, that may be converted to an open-cell foam); cellulose sponges, polyvinylalcohol sponges, urea formaldehyde sponges, and the like. Closed cell foams that allow leakage of the immiscible fluid from the reservoir to the barrier meniscus may also be suitable reservoirs. These may include certain polystyrene or polyolefin foams or other suitable thermoplastic foam structures.

In other embodiments, reservoirs may include fibrous structures, such as felts, other non-woven fabrics, and woven fabrics. Paper is an example of a non-woven fibrous matrix. Such materials may be constructed from natural or synthetic fibers. Any of the above materials may benefit from resin impregnation to increase their rigidity, chemical resistance, wetability for the immiscible fluid, moldability, and extreme temperature and flame resistance.

In yet other embodiments, reservoirs may be constructed from solid rubber components, such as o-rings and lip seals, or any other such components that are capable of imbibing the immiscible fluids in production and/or are capable of releasing the fluids gradually under service conditions. Modifying the rubber composition with porous ingredients such as fibers and inorganic porous fillers may enhance the rubber's ability to entrain immiscible fluids. Fluorocarbon, nitrile, chloroprene, silicone and fluorosilicone, styrene-butadiene, natural (cis- or trans-), polyisoprene, ethylene-propylene (EPR) or ethylene-propylene-diene (EPDM), butyl, and polyurethane rubbers may be suitable as reservoir materials. Specialty rubbers, such as acrylic homo- and co-polymers, hydrin rubbers based on epichlorhydrin, polysulfides, chlorosulfonated polyethylene (e.g., Hypalon), and others may also be suitable.

One method for introducing the immiscible fluid into solid rubber components is to swell the rubber in a volatile liquid containing the immiscible fluid followed by evaporation of the swelling fluid, thus entraining the immiscible barrier fluid within the rubber component. Another method for incorporating immiscible fluids into rubber components is to add the immiscible fluid to the rubber composition during processing on rubber mills or Banburies or similar processing equipment. Porous or fibrous components (both inorganic or organic) may or may not be included in this processing stage.

FIG. 2 illustrates a schematic block diagram of an alternative example seal assembly 200. Seal assembly 200 is similar to seal assembly 100 with the addition of unwettable surfaces 215. Unwettable surfaces 215 may be embodied as, for example, PTFE, PVC, polyolefins, polyurethanes, or other organic polymer bands added to shaft 210 to prevent its wetting by an immiscible fluid 230, such that immiscible fluid 230 may not migrate or seep out of the desired seal zone. Another useful property to maintain the seal is thixotropy, which may cause the immiscible fluid to gel or solidify when the shear rate of the moving immiscible fluid 230 is low.

Features in the example seal assemblies may enhance a labyrinthine structure that, when filled with the immiscible fluid, may be resistant to internal pressure within the larger device. Lubricating oil (220) to be held in the larger device may be immiscible with the immiscible fluid retained by the seal structure. With the proper selection of immiscible fluid properties, the immiscible fluid and the internal lubricating oil will not emulsify and will remain separated. An additional close fitting structure may be provided to assist in keeping the immiscible fluid and the lubricating oil from emulsifying.

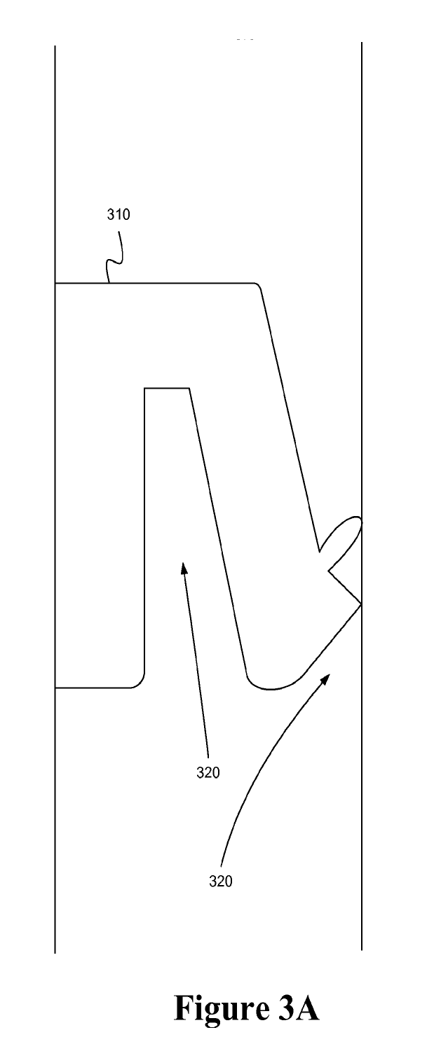

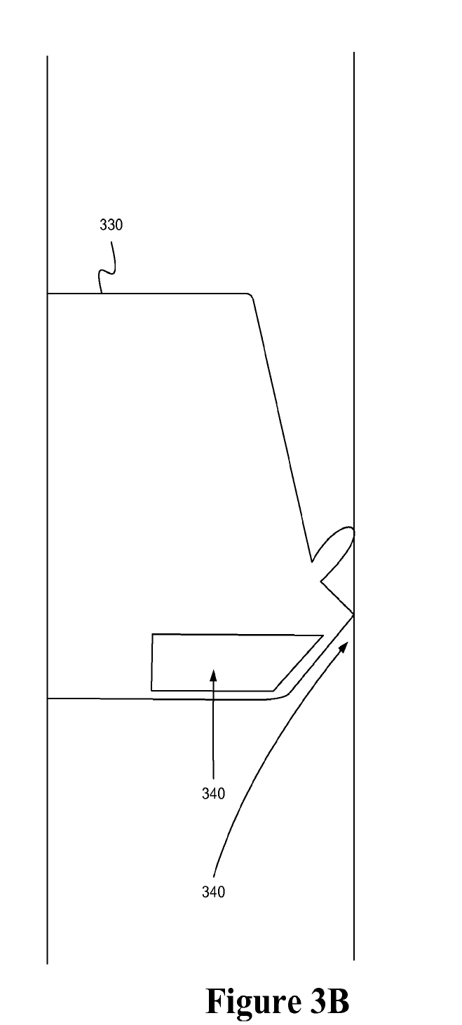

FIGS. 3A and 3B illustrate alternate seal structure configurations. In FIG. 3A, seal structure 310 retains immiscible fluid (not shown) in reservoir 320. In FIG. 3B, seal structure 330 retains immiscible fluid (not shown) in reservoir 340. The described example seal assemblies may be non-contacting in the manner described above, with macroscopic components, structures, and devices to accomplish the immiscible fluid barrier seal.

In another embodiment, a seal assembly is provided. The seal assembly comprises a seal structure in close proximity to and contacting a shaft. The seal structure further comprises a primary seal material and an immiscible fluid. The immiscible fluid may be released from the seal structure as the seal structure wears, and the immiscible fluid may create a fluid barrier for a lubricating oil to limit a loss of the lubricating oil.

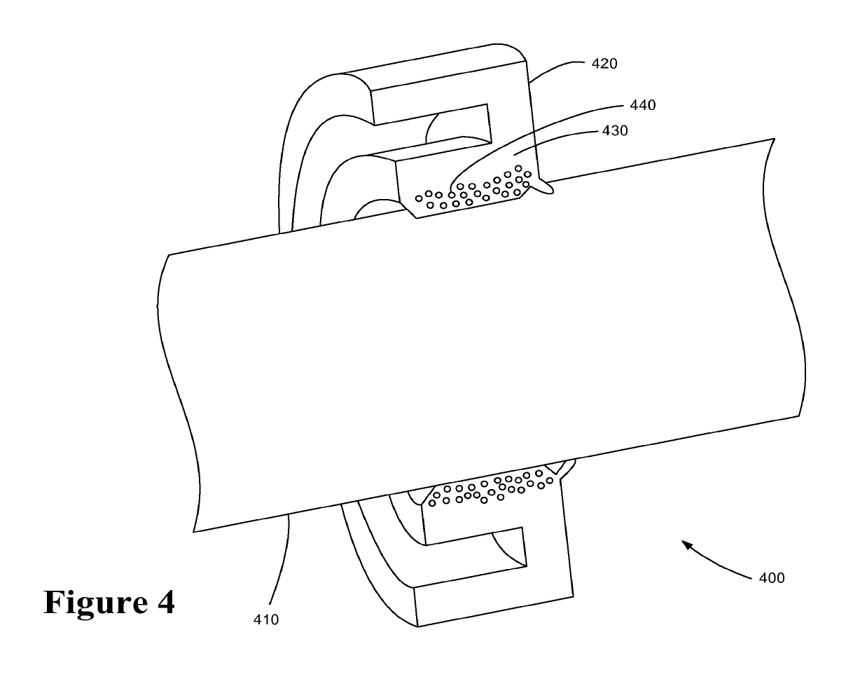

Referring now to FIG. 4, an example seal assembly 400 is illustrated employing a seal structure 420 encircling a shaft 410. Seal structure 420 comprises a primary seal material 430 and an immiscible fluid 440. As illustrated, seal structure 420 incorporates the immiscible fluid 440 into the primary seal material 430. In one embodiment, the immiscible fluid 440 is mixed into unreacted rubber. The rubber is then cross-linked by vulcanizing about the small droplets of the immiscible fluid, thereby incorporating the immiscible fluid into the reservoir structure. This finely integrated structure has an intrinsic lubrication in which a very small amount of the immiscible fluid may be released as the seal structure wears, leaving a very thin film of the immiscible fluid to lubricate the seal and prevent dry contact between the shaft and the stationary structure. The thin film of this seal structure with the nonconventional intrinsically-lubricated material may provide a seal that can potentially last an order of magnitude beyond a typical conventional seal performance.

Many seal assembly failures are primarily due to a lack of lubrication in the seal structure's nip. The described seal assembly may at least partially limit this type of failure by providing a self-lubricating seal structure.

In another embodiment, a seal assembly is provided. The seal assembly comprises an oil barrier comprising a rubber material (e.g., a conventional solid rubber) and a fluid reservoir, wherein the rubber material and the fluid reservoir are operably connected (e.g., via co-molding, adhesion, or other means of attachment or association) such that the rubber material is occasionally, regularly, or constantly supplied with a fluid. The fluid may comprise, for example, an immiscible fluid or a conventional lubricant.

### Synthesis of Fluorocarbon Materials

Fluorocarbon monomers with chemically reactive functionality are commercially available from Solvay Solexis, Inc. under the trade name “Fluorolink®”. These materials offer the opportunity to synthesize highly fluorinated polymers with the potential of acting: (a) as hydrocarbon and polyglycol lubricant barriers; and/or (b) as reservoirs for lubricant-immiscible fluid(s).

Various structures were synthesized, including viscous fluids and gels, soft and hard waxes, resilient and rigid plastics, and open cell foams. Primary building blocks for these compositions included di-hydroxyfunctional Fluorolink D and E-10, and tetra-hydroxyfunctional Fluorolink T in combination with one or more of the following ingredients: Voranol polyether polyol 230-660, isophorone diisocyanate, toluene diisocyanate, hexamethylene diisocyanate, diphenylmethane diisocyanate, PAPI (polyphenyl isocyanate, an MDI oligomer), 30% Torlon polyamide-imide in NMP, DMEA (dimethylethanolamine), stannous octoate, dibutyltin dilaurate, HEMA (hydroxyethyl methacrylate), TMPTA (trimethylolpropanetriacrylate), CFC 13, and water. A number of Fluorad® surfactants from 3M Co. were also investigated with several compositions, including Fluorad FC-129, FC-143, FC- 170 and FC-171. Several reactions were carried out in the presence of Krytox GPL-103 fluorolubricants, incorporating this fluorolubricant oil directly into the foam structure during the polymerization.

In other experiments, experimental foams were prepared first and loaded with Krytox afterwards. Krytox and Fomblin loading of commercial open cell silicone foams was also accomplished. Similarly, an experimental fluorocarbon viscous fluid was loaded into commercial silicone foam. The latter released the gel readily upon squeezing, but did not lose fluid after being placed into an oven at 93° C. for 16 hours. Several experimental structures were exposed to 200° F. for 16 hours without changing their appearance.

### Fluorocarbon Functionalization of Paper

In other experiments, fluorocarbon-reacted paper was tested as a medium for containment of the immiscible liquid within either rubber, fibrous, or open-celled foam reservoirs. The fluorocarbon-reacted paper may also function as a physical reinforcement of any of these types of reservoir and to protect them from outside contamination, either particulate or liquid. It was experimentally demonstrated that such a paper could be co-molded to a fluorocarbon rubber reservoir during vulcanization. Attachment to fibrous or foam reservoirs may be accomplished with any one of several types of adhesives or resin binders, including either thermoplastic or thermoset materials. Paper may also be substituted by any of a variety of woven or nonwoven fabrics or fibers.

For example, fluorocarbon treatments of cellulosic filter papers (Whatman #3 and #113) with Fluorolink® F-10 (phosphate-functional perfluoro-polyether from Solvay Solexis, Inc.) were successful in inhibiting the absorption of both hydrocarbon and polyalkylene glycol lubricants. Water absorption was similarly inhibited. Further evidence of the success of the treatment derives from the consistent and substantial weight gain (from about 20 to 35%) of the filter paper samples after treatment and drying.

### Preparation of Rubber Reservoirs for Fluorolubricants

Further experiments focused on the preparation of rubber reservoirs for fluorolubricants. Developing a rubber seal modified with a fluorolubricant provides a direct replacement for many of the current seals in commerce.

In one experiment, Viton, a fluorocarbon rubber, was selected in accordance with: (a) its high chemical resistance (including resistance to hydrocarbon and polyglycol lubricants); (b) its high temperature resistance; and (c) its expected high affinity for fluorolubricants. Swelling of either the cured or uncured Viton rubber (DuPont fluorocarbon rubber) in a variety of fluorocarbon fluids encountered difficulties even at elevated temperatures. It was concluded that more traditional rubber processing methods, such compounding on a mill or a Banbury, may solve this issue.

Milling experiments were carried out on a two-roll mill and on a Brabender sigma blade mixer with Viton grades A-100, GLT-200 and GLT-6005, copolymers of vinylidene fluoride and hexafluoropropylene, or terpolymers of the same copolymer composition with fluorinated vinyl ether. Experiments included both unfilled rubber compositions and compositions filled variously with carbon black (N990) or Wollastonite 905U. The fluorocarbon lubricants added in different milling experiments included Fomblin® Y-45 (from Solvay Solexis) and Krytox® GPL 103 and 105 (from DuPont). Some of the rubber formulations were prepared without vulcanizing agents and some did include such agents, for example, Luperco 101 XL peroxide, Diak 7 accelerator (1,3,5-triallylisocyanurate, C₁₂H₁₅N₃O₃), and zinc oxide. Milling was carried out from 250 to 400 F in different experiments. It was found that the higher temperatures were required for measurable loading of the oil into the rubber. Several experiments also included alkali [NaOH or Ca(OH)₂] in an attempt to break down some of the fluorocarbon structure of the rubber to increase fluorolubricants loading. Calculations based on weight change suggest incorporation of fluorocarbon lubricants in the 10-20% range (by weight in the final product) was obtained.

### Oil Leakage Prevention with Immiscible Fluid

Experiments were also conducted to determine whether oil leakage was prevented using an immiscible fluid. In one experiment, a silicone rubber sponge, Bisco BF-1000, was filled with Krytox® GPL 105 fluorocarbon lubricant by immersing it in the liquid and drawing a vacuum on the container. The filled foam contained from 9-10 times its original (dry) weight as fluorolube, accounting for a fill factor of about 79% by volume. Storage for 48 hours in air on aluminum foil indicated little tendency for the foam to lose fluid. Similar results were obtained by substituting Fomblin® Y-45 for the Krytox, registering 10.5 times weight gain of the silicone foam after impregnation.

The test apparatus consisted of a specially designed rig in which the impregnated foam seal was held in a ½-inch thick “cartridge,” which was installed in a 3-inch long steel sleeve. The back-side of the sleeve was fitted with a standard lip seal, thus creating a cavity in the sleeve behind the foam-containing cartridge which could be filled with up to 20 ml of fluid. A steel shaft penetrated both seals, and was ground to provide a finish that would simulate the shaft of a gear-box or other device which would benefit from the seal assembly. The shaft was driven by pulley and belt connected to a motor operated with a programmable controller. The controller provided a range of shaft speeds between 500 and 5000 rpm.

A test was run at successively increasing speeds of 900 rpm, 1950 rpm and 2400 rpm with Mobil SHC 634 hydrocarbon lubricant inside the sleeve cavity, behind a silicone foam ring containing Fomblin Y-45 fluorocarbon oil. The silicone foam had been cut to provide a 0.020-in interference with the rotating shaft. Fluid collected on the outside of the seal was tested with a Digilab FTS-60A infrared spectrometer equipped with a UMA 600 microscope. A spectrograph was obtained from 4000 to 400 cm-1 wave numbers. No evidence of hydrocarbon oil was detected, indicating that the Fomblin-filled silicone foam prevented the synthetic hydrocarbon lubricant from penetrating to the outside.

In each of the disclosed embodiments, the immiscible fluid layer, however thin the film may be, is the seal between the moving part, such as a shaft, and the stationary part, such as a casing. By making the seal a fluid rather than a solid-to-solid contact seal, even those with formed hydrodynamic film, the seal maintains a very low friction and negligible wear.

Unless specifically stated to the contrary, the numerical parameters set forth in the specification are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and so on have been illustrated by describing experimental results, and while the experimental results have been described in considerable detail, it is not the intention of the applicant to restrict, or in any way, limit the scope of the appended claims to such detail. It is, of course, not possible to describe every conceivable combination of components or methodologies for purposes of describing the material components, systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

What is claimed is:

1. A shaft seal assembly, comprising:
an immiscible fluid, the immiscible fluid being immiscible with respect to an internal fluid; and
a reservoir structure disposed in close proximity to a shaft, the reservoir structure defining the placement of the immiscible fluid with respect to the internal fluid;
thereby providing a fluid barrier between the internal fluid and the immiscible fluid to limit a loss of the internal fluid over time.

2. The seal assembly of claim 1, further comprising at least one band surrounding a portion of the shaft in close proximity to the reservoir structure; and
thereby preventing migration of the immiscible fluid along the shaft.

3. The seal assembly of claim 1, wherein the immiscible fluid is incorporated into the reservoir structure.

4. The seal assembly of claim 3, wherein the reservoir structure comprises a rubber vulcanized about the immiscible fluid.

5. The seal assembly of claim 1, wherein the immiscible fluid is thixotropic, thereby gelling when a shear rate of the immiscible fluid is below a predetermined threshold.

6. The seal assembly of claim 1, wherein the immiscible fluid is a fluorocarbon.

7. The seal assembly of claim 1, wherein the immiscible fluid is aqueous-based.

8. The seal assembly of claim 3, wherein the reservoir structure comprises an open-celled polymer foam.

9. The seal assembly of claim 3, wherein the reservoir structure comprises a fibrous structure.

10. The seal assembly of claim 1, wherein the reservoir structure comprises a rubber comprising at least one of a homo-polymer of a fluorocarbon, a co-polymer of a fluorocarbon, a nitrile, a chloroprene, a polyurethane, an acrylate, a hydrin, a polysulfide, a polyolefin, a silicone, a fluorosilicone, a polysulfide, a chlorofluorinated polyethylene, a styrene-butadiene, a polyisobutylene copolymer, a polybutadiene, and a polyisoprene.

11. A shaft seal assembly, comprising:
an immiscible fluid, the immiscible fluid being immiscible with respect to a lubricating oil; and
a reservoir structure disposed in close proximity to a shaft, the reservoir structure defining the placement of the immiscible fluid with respect to the lubricating oil;
thereby providing a fluid barrier between the lubricating oil and the immiscible fluid to limit a loss of the lubricating oil over time.

12. The seal assembly of claim 11, further comprising at least one band surrounding a portion of the shaft in close proximity to the reservoir structure; and
thereby preventing migration of the immiscible fluid along the shaft.

13. The seal assembly of claim 11, wherein the immiscible fluid is incorporated into the reservoir structure.

14. The seal assembly of claim 13, wherein the reservoir structure comprises a rubber vulcanized about the immiscible fluid.

15. The seal assembly of claim 11, wherein the immiscible fluid is thixotropic, thereby gelling when a shear rate of the immiscible fluid is below a predetermined threshold.

16. The seal assembly of claim 11, wherein the immiscible fluid is a fluorocarbon.

17. The seal assembly of claim 11, wherein the immiscible fluid is aqueous-based.

18. The seal assembly of claim 13, wherein the reservoir comprises an open-celled polymer foam.

19. The seal assembly of claim 13, wherein the reservoir comprises a fibrous structure.

20. The seal assembly of claim 1, wherein the reservoir comprises a rubber comprising at least one of a homo-polymer of a fluorocarbon or co-polymer of a fluorocarbon, a nitrile, a chloroprene, a polyurethane, an acrylate, a hydrin, a polysulfide, a polyolefin, a silicone, a fluorosilicone, a polysulfide, a chlorofluorinated polyethylene, a polyisobutylene copolymer, a styrene-butadiene, a polybutadiene, and a polyisoprene.

21. A seal assembly, comprising:
a seal structure in close proximity to a shaft, the seal structure comprising a primary seal material and an immiscible fluid, wherein the immiscible fluid is released from the seal structure as the seal structure wears; and wherein the immiscible fluid creates a fluid barrier with respect to an internal fluid to limit a loss of the internal fluid.

22. The seal assembly of claim 21, wherein close proximity includes direct contact with the shaft.

23. The seal assembly of claim 21, wherein the primary seal material comprises at least one of: a rubber, an open cell foam, and a fibrous continuous pore structure for containing the immiscible fluid.

24. A seal assembly, comprising: an oil barrier comprising a rubber material and a fluid reservoir, wherein the rubber material and the fluid reservoir are operably connected such that the rubber material is supplied with a fluid; and wherein the fluid comprises an immiscible fluid.
